(19) United States
(12) Patent Application Publication
(10) Pub. No.: US 2015/0183993 A1
(43) Pub. Date: Jul. 2, 2015

(54) METHOD FOR PROCESSING A HIGH TEMPERATURE RESISTANT THERMOSETTING MATERIAL

(71) Applicants: Keki Hormusji Gharda, Bandra (West), Mumbai, Maharashtra (IN); Prakash D. Trivedi, Khar (West), Mumbai, Maharashtra (IN); Tushar R. Parida, Thane (West) (IN); Amitkumar Biradar, Pune (IN)

(72) Inventors: Keki Hormusji Gharda, Bandra (West), Mumbai, Maharashtra (IN); Prakash D. Trivedi, Khar (West), Mumbai, Maharashtra (IN); Tushar R. Parida, Thane (West) (IN); Amitkumar Biradar, Pune (IN)

(21) Appl. No.: 14/414,200

(22) PCT Filed: Jul. 11, 2013
(86) PCT No.: PCT/IN2013/000430

§ 371 Date: Jan. 12, 2015

(30) Foreign Application Priority Data
Jul. 12, 2012 (IN) 2018/MUM/2012

(51) Int. Cl. C08L 79/04; C08L 81/06; B29C 43/00; C08L 61/16

(52) U.S. Cl. CPC C08L 79/04; C08L 61/16; C08L 81/06; B29C 43/003; C08L 2201/08; B29K 2079/00

(57) ABSTRACT

The present disclosure provides a polymeric composition resistant to temperatures comprising Poly 2,5rBenzimidazole having intrinsic viscosity (I. V.) between 1.0 and 2.5; and at least one binder having a glass transition temperature less than the glass transition temperature of Poly2,5-Benzimidazole and intrinsic viscosity ranging between 0.2 and 1.5. The present disclosure also provides a process for preparing the polymeric composition resistant to temperatures.

### FIELD OF THE DISCLOSURE

The present disclosure relates to a high temperature resistant thermosetting material. The present disclosure also relates to a process for preparing articles from a high temperature resistant thermosetting material.

### BACKGROUND

ABPBI or Poly 2,5-Benzimidazole (PBI) is a thermosetting polymer represented by the molecular formula: —(C₇H₄N₂)ₙ—. It is a solid, odorless, brown to black colored substance with specific gravity in the range of 1.28-1.33. It is insoluble in water & organic solvents and has no freezing or melting point. The polymer cannot be melt processed up to 500° C. due to its high glass transition temperature (Tg) and the absence of Melting temperature (Tm) levels until 500° C. The polymer is thus extremely high temperature stable, but evidently difficult to process. ABPBI is also highly chemical resistant (it does not even ignite) and can even be made into a fiber with excellent textile and tactile performance. In spite of possessing exceptional properties that deserve applications in various areas, for instance fire departments and space agencies, it has not been fully explored as a precursor due to difficulty in its processing. Until now it has found application just as a solution cast membrane and has been evaluated as phosphoric acid impregnated proton exchange fuel cell membrane. The need for an effective solution that makes such a unique and useful polymer processable is thus palpable.

### DEFINITIONS

As used in the present disclosure, the following words and phrases are generally intended to have the meaning as set forth below, except to the extent that the context in which they are used to indicate otherwise.

The expression ‘resistant to temperature’ indicates resistance of an object or material to change in dimension or structure due to heat.

### OBJECTS

Some of the objects of the present disclosure, which at least one embodiment is adapted to provide, are described herein below:

It is an object of the present disclosure to provide a temperature resistant thermosetting polymer.

An object of the present disclosure to increase the industrial applicability of the temperature resistant thermosetting polymer.

Another object of the present disclosure is to overcome the inherent barriers in the form of physical properties in order to render the temperature resistant thermosetting polymer processable.

Still another object of the present disclosure is to address the problem of difficulty in processability of the temperature resistant thermosetting polymer.

A further object of the present disclosure is to provide a process for preparing an easy to process temperature resistant thermosetting polymer.

Still further object of the present disclosure is to provide a precursor for manufacturing general engineering articles that are heat and chemical resistant.

Other objects and advantages of the present disclosure will be more apparent from the following description which is not intended to limit the scope of the present disclosure.

### SUMMARY

In one aspect of the present disclosure there is provided a polymeric composition resistant to temperatures comprising:
a. Poly 2,5-Benzimidazole having inherent viscosity (I.V.) between 1.0 and 2.5; and
b. at least one binder having a glass transition temperature less than the glass transition temperature of Poly 2,5-Benzimidazole and inherent viscosity ranging between 0.2 and 1.5,
subjected to compression at a temperature ranging between 400 and 600° C. and a pressure ranging between 1000 psi and 10000 psi,
wherein said composition is characterized by:
i. a glass transition temperature ranging between 150 and 480° C.; and
ii. the ratio of Poly 2,5-Benzimidazole to the binder ranges between 95:5 and 5:95.

In one embodiment of the present disclosure the ratio of Poly 2,5-Benzimidazole to the binder ranges between 95:5 and 50:50.

Typically, the binder is selected from the group consisting of Poly Ether Ketone (PEK), Poly Aryl Ether Ketone (PAEK), Poly Ether Ether Ketone (PEEK), Poly Ether Ketone Ketone (PEKK), Polyphenelene Sulfide (PPS), Polyether Imdia (PEI), Poly Ether Sulfones (PES) and Polyphenylsulfone (PPSU).

Preferably, the binder is selected from the group consisting of Poly Ether Ether Ketone (PEEK), Polyether Ketone (PEK) and Poly Ether Sulfone (PES).

In another aspect of the present disclosure there is provided a process for preparing a polymeric composition resistant to temperatures comprising 2,5-Benzimidazole and at least one binder; said process comprising the following steps:
blending Poly2,5-Benzimidazole and at least one binder to obtain a dry powder mixture; and
molding said mixture by heating at a temperature ranging between 400° C. and 600° C. for a time period ranging between 0.5 hour and 4 hours at a pressure ranging between 1000 psi and 10000 psi in a compression mold, followed by cooling to obtain a polymeric composition resistant to temperatures in the form of a shaped article selected from the group consisting of discs, chips, plates, tubes and rods,
wherein said composition characterized in that the glass transition temperature ranging between 150 and 480° C.

Typically, the binder is at least one compound having a glass transition temperature lower than the glass transition temperature of Poly 2,5-Benzimidazole.

Typically, the binder is selected from the group consisting of Poly Ether Ketone (PEK), Poly Aryl Ether Ketone (PAEK), Poly Ether Ether Ketone (PEEK), Poly Ether Ketone Ketone (PEKK), Polyphenelene Sulfide (PPS), Polyether Imide (PEI), Poly Ether Sulfones (PES) and Polyphenyl Sulfone (PPSU).

Typically, the inherent viscosity (I.V.) of Poly 2,5-Benzimidazole ranges between 1.0 and 2.5.

Typically, the inherent viscosity of the binder ranges between 0.2 and 1.5.

In one embodiment of the present disclosure the ratio of Poly 2,5-Benzimidazole to the binder ranges from 95:5 and 95:5. In another embodiment of the present disclosure the ratio of Poly 2,5-Benzimidazole to the binder ranges between 95:5 and 50:50.

### DETAILED DESCRIPTION

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

ABPBI is a thermosetting polymer that cannot be melt processed up to 500° C. due to very high glass transition temperature (Tg) of 485° C. and absence of melting temperature (Tm) until 500° C. It is thus evident that this polymer is difficult to process but is extremely stable at high temperatures.

The present disclosure addresses this problem of difficulty in processability of the polymer. The inventors of the present disclosure found that ABPBI thermoplastic polymer can be made processable by blending it with a binder. The binder blended with ABPBI lowers the softening temperature of ABPBI polymer. It is due to lowered softening temperature that the processing of ABPBI is feasible. This blend can be easily processed to make articles like gaskets, seals, thrust bearings, that would be immensely useful for high temperature, high hardness, chemical and flame resistant applications in oil and gas industries.

In accordance with one aspect of the present disclosure there is provided a polymeric composition resistant to temperatures comprising Poly 2,5-Benzimidazole (ABPBI) and at least one binder subjected to compression at a temperature ranging between 400° C. and 600° C. and a pressure ranging between 1000 psi and 10000 psi. The polymeric composition is characterized by a glass transition temperature ranging between 150° C. and 480° C.

The binder and the amount of the binder to be used in the polymeric composition is such selected in such a way that it is capable of reducing the softening temperature of Poly 2,5-benzimidazole (ABPBI) to an extent to make ABPBI processable.

Further, during the experimentation it was observed that in order to render ABPBI processable the glass transition temperature of the binder should be lower than the glass transition temperature of ABPBI. Still further, the ability of the binder to bind with ABPBI plays a important role in deciding the extent of lowering the glass transition/softening temperature of ABPBI.

Such binder includes but is not limited 10-Poly Ether Ketone (PEK), Poly Aryl Ether Ketone (PAEK), Poly Ether Ether Ketone (PEEK), Poly Ether Ketone Ketone (PEKK), Polyphenelene Sulfide (PPS), Polyether Imide (PEI), Poly Ether Sulfones (PES) and Polyphenyl Sulfone (PPSU). The amount of the binder also depends on the purpose of use of the final material/article. Therefore, depending of the use on the one hand and making ABPBI processable on, the other hand, the ratio of ABPBI to the binder may vary from 95:5 to 5:95. In accordance with one of the exemplary embodiments of the present disclosure the ratio of Poly 2,5-Benzimidazole to the binder ranges between 95:5 and 50:50.

Further, the intrinsic viscosity (I.V.) of ABPBI and the binder in combination with the amount of the individual components of the polymeric composition has an effect on the chemical and the physical properties of the resulting polymeric composition.

In an exemplary embodiment, the composition made up of a blend comprising ABPBI having intrinsic viscosity 1.2 and Poly Ether Ketone having intrinsic viscosity 1.0 in the ratio of 95:5 will have different properties compared to that of the composition made up of blend comprising. ABPBI having intrinsic viscosity 1.8 and poly Ether Ketone having intrinsic viscosity 1.0 in the ratio of 90:10.

Therefore, to obtain a polymeric composition of predetermined properties, the intrinsic viscosity of ABPBI may be varied in the range of 1.0 to 2.5, whereas the intrinsic viscosity of the binder may range between 0.2 and 1.5.

In accordance with another aspect of the present disclosure there is provided a process for preparing a polymeric composition resistant to temperatures comprising Poly 2,5-Benzimidazole (ABPBI) and at least one binder. The polymeric composition prepared in accordance with the process of the present disclosure has a glass transition temperature falling in the range of 150° C. to 480° C.

In the first step, ABPBI having intrinsic viscosity in the range of 1.0 to 2.5 and fine powder of binder are blended in a high speed mixer to obtain a dry mixture. The binder used to blend with ABPBI has a glass transition temperature lower than the glass transition temperature of Poly 2,5-Benzimidazole and intrinsic viscosity of 0.2 to 1.5. The binder employed includes but is not limited to PEK or PAEK, PEEK, PEKK, PPS, PEI, PES and PPSU, individually or in blends. To obtain optimum results the ratio of ABPBI to the binder is maintained between 95:5 and 50:50.

In the second step, the mixture is transferred to a mold and heated by a ceramic band heater in a compression molding machine at a temperature ranging between 400° C. and 600° C. for a time period ranging between 0.5 hour and 4 hours at a pressure ranging between 1000 psi and 10000 psi.

Finally, the mold in the compression press is cooled to obtain a polymeric composition. The polymeric composition resistant to temperatures obtained may be in any form of the shaped article which include but is not limited to discs, chips, plates, tubes, rods and the like.

The present disclosure is further described in light of the following non-limiting examples which are set forth for illustration purpose only and not to be construed for limiting the scope of the disclosure.

### Example 1

100 g of ABPBI polymer I.V. (Inherent Viscosity 1.8) fine powder of Particle size<400 microns was poured inside a 110 mm internal diameter compression disc mold (electrically heated by external band heaters). The mold was then loaded onto a 50 ton compression press (LABTECH LPS-50) and the powder was pressed for 3 hrs at 500° C. at 2000 psi pressure in a compression molding press. It was subsequently cooled to 120° C. before removing the disc from the mold. One 5-6 mm thick round disc of 110 mm diameter was ejected out for further testing. The disc was found to be very hard, with dark green color. However, there were cracks all over on the surface. The surface was, otherwise, smooth and shiny but on cutting with a circular saw, it was seen that inside portion had not fused or melted at all and had retained powdery grainy look. Also, on cutting, the disc shattered into smaller pieces. The edges could even be chipped off at the deep cracks simply by hand pressure.

### Example 2

The experiment 1 was repeated with ABPBI powder of I.V. 1.2. Similar disc could be obtained, which was also hard, dark green in color and was difficult to remove from the die mold. It had, however, more cracks than specimen from example 1 and was more prone to shatter on cutting with a saw. The inside surface was grainy indicating that no fusion or melting had taken place.

### Example 3

Fine powder of ABPBI (I.V. 1.2) was dry blended with fine powder of PEK (I. V. 1.0, G-PAEK) in the ratio of 95:05 for 5 minutes in a high-speed mixer. The mix was poured into a 110 mm internal diameter cylindrical disc mold and heated by ceramic band heaters. The mold was then loaded onto a 50 ton compression press (LABTECH LPS-50). The powder was pressed on the compression press at 500° C. and 2000 psi pressure for 1 hour and molded disc was removed after cooling and tested for Storage Modulus by Dynamic Mechanical Analysis, Taber Abrasion (weight loss) and hardness after cutting in needed shape of specimen. It was observed that the ABPBI disc so produced did not shatter on cutting and the inside surface found to be completely fused. No major cracks or chippings were observed on the surface of the disc.

### Example 4

The example 3 was repeated for compression molding for 2 hours of pressing time. The cooled disc could be removed from the mold without breaking and could be cut by a circular saw without shattering. The inside surface found to be smooth and fused under this conditions.

### Example 5

The example 3 was repeated for compression molding for 3 hours of pressing time. The cooled disc could be removed from the mold without breaking and could be cut by a circular saw without shattering. The inside surface found to be smooth and fused under this conditions.

### Example 6, 7 & 8

Examples 3, 4 and 5 were repeated using ABPBI grade of 1.8 I.V blended with PEK of IV 1.0 in the ratio of 90:10. The molded discs were machined in a lathe to produce test specimens. It was observed that ABPBI molded discs were very hard and somewhat difficult to be machined. The machining tool also got worn out somewhat on cutting the disc. The inside surface was found to be completely fused and melted. The solidified polymer was not grainy and powdery in appearance.

### Example 9

Example 3 was repeated at temperatures of 400° C. (Example 7), 450° C. (Example 8) and 500° C. (Example 9) but by using a blend of 90% ABPBI and 10% PEK. The discs so prepared were well fused, hard and could be cut into specimens for testing.

### Example 10

Examples 3, was conducted with 5% PEEK as binder of ABPBI instead of PEK. The molding was carried out at 450° C. and the disc was cooled to 120° C. and ejected. The ejection was easy and the color of the disc was lighter than color of all other compositions containing PEK and PEKK.

### Example 11

Examples 3 was conducted using PEKK as a binder instead of PEK. 5% PEKK powder was mixed with 95% ABPBI powder of 1.8 IV and compression molded at 450 deg C./1 hour pressing time. The part could be easily ejected and had dark brown color. It did not show cracks and did not break on machining.

### Example 12

Examples 3 was conducted using PES (Polyether Sulfone) as binder instead of PEK. 5% PES powder was mixed with 95% ABPBI powder of 1.8 I.V. and compression molded at 450° C. for 1 hour. The disc could be ejected and showed no sign of cracking.

### Example 13

5% of PEK having 0.7 intrinsic viscosity (G-PAEK 1400P) was used as a binder instead of 5% of PEK having 1.0 intrinsic viscosity as described in Example 3. The product could be ejected well and had good taber abrasion resistance.

### Example 14 TO 23

A dry blend of ABPBI:PEK (1.0 I.V.) in the proportion of 95:5 was prepared and compression molded at 450° C. for 1 hour at 2000 psi (Example 14).

Other compositions of ABPBI:PEK were also prepared as under and molded at 450° C. for 1 hour at 2000 psi pressure.

ABPBI:PEK: (90:10)—Example 15

ABPBI:PEK (80:20)—Example 16

ABPBI:PEK: (70:30)—Example 17

ABPBI:PEK: (60:40)—Example 18

ABPBI:PEK: (50:50)—Example 19

ABPBI:PEK: (40:60)—Example 20

ABPBI:PEK: (30:70)—Example 21

ABPBI:PEK: (20:80)—Example 22

ABPBI:PEK: (10:90)—Example 23

In all the above cases, strong, whole discs could be ejected without cracks or chippings and they could be cut into specimens required for various testing.

### Example 24

A composition of 60% PEK of 1.0 I.V. and 40% ABPBI of 1.8 I.V. was compression molded at 500° C. for 1 hour at 2000 psi pressure. The disc could be well ejected. The surface was very smooth and there was no cracking or chipping on any of the edges or surface. Taber abrasion was studied for some samples and values are given in Table 1.

(Wheel Used: CS-17, Load: 1 Kg, Re-facing: 1000 cycles.)

TABLE 1
Comparative study of Taber abrasion for up to 5000 cycles for the
ABPBI discs prepared in accordance with the process of present
disclosure:

| | Weight loss (mg) | | | | |
|---|---|---|---|---|---|
| Example | No. of Cycles | | | | |
| No. | 1000 | 2000 | 3000 | 4000 | 5000 |
| 3 | 19 | 37 | 52 | 65 | 75 |
| 4 | 18 | 35 | 48 | 55 | 70 |
| 5 | 14 | 13 | 31 | 45 | 61 |
| 10 | 13.1 | 23.2 | 36.5 | 44.1 | 54 |
| 11 | 23.7 | 38.4 | 60.2 | 87.8 | 107.8 |
| 12 | 13.5 | 24.50 | 31.0 | 41.7 | 52.9 |
| 13 | 15.1 | 31.3 | 37.4 | 53.7 | 69.1 |
| 14 | 18.6 | 29.3 | 45.6 | 60.4 | 75.6 |
| 15 | 23.3 | 44.5 | 57.5 | 75.1 | 94.1 |
| 16 | 23.3 | 44.5 | 57.5 | 75.1 | 94.1 |
| 17 | 16.2 | 30.6 | 44.3 | 55.6 | 65.8 |
| 18 | 11.2 | 19.2 | 29.3 | 37.4 | 44.3 |
| 19 | 12.1 | 25.2 | 34.6 | 40.4 | 49.2 |
| 20 | 19.7 | 33.4 | 41.8 | 48.4 | 56.6 |
| 21 | 10.3 | 19.6 | 28.8 | 40.1 | 49.8 |
| 22 | 14.7 | 26.9 | 41.1 | 52.4 | 66 |
| 23 | 19.5 | 38.7 | 49 | 76.6 | 88.7 |
| 24 | 10 | 12 | 27 | 30 | 40 |

In general; ABPBI alone has more abrasion as compared to ABPBI bonded with PEK. Higher the PEK, content, lower is the abrasion and greater is the abrasion resistance. ABPBI acts as a polymeric particulate filler in the matrix which gets bonded by presence of PEK. Higher the PEK content, better is the bonding and lower is usually the abrasion loss. Significantly, addition of a binder is necessary for making compression molded ABPBI. PEEK and PES as binders also give lower abrasion losses. Thus, a binder with higher flow and lower melting have possibly a better wetting of the matrix and thus better bonding.

PEK of lower I.V. (0.7) gave lower abrasion loss as compared to PEK of higher I.V. (1.0) due to better bonding.

TABLE 2
Dynamic Mechanical Analysis (DMA) of ABPBI & PEK samples

| | | Room | | | | | |
|---|---|---|---|---|---|---|---|
| Samples | | Temp | 150° C. | 250° C. | 350° C. | 400° C. | Tg |
| ABPBI/ | Exam- | 3015 | 2709 | 2117 | 1389 | 1186 | 464 |
| PEK- | ple 3 | | | | | | |
| (95/5) | | | | | | | |
| ABPBI/ | Exam- | 1701 | 1497 | 333 | 164 | — | 175 |
| PEK- | ple 12 | | | | | | |
| (40/60) | | | | | | | |
| PEK | | 1220 | 857 | 77 | — | — | 170 |
| (un- | | | | | | | |
| filled) | | | | | | | |
| ABPBI | | | | | | | 485 |

From the dynamic mechanical analysis and the results provided in table 2, it is observed that the glass transition temperatures (Tg) of PEK and ABPBI are 170° C. and 485° C. respectively, whereas Tg of the composition comprising ABPBI and PEK in the ratio 95:5 is 464° C. and the Tg of the composition comprising ABPBI and PEK in the ratio 40:60 is 175° C.

Thus, it is found that the glass transition temperature of ABPBI is reduced by incorporation of the binding agent such as PEK, PEEK, PEKK, PES, and PAEK, rendering the resulting polymeric composition processable. In other words, ABPBI moldings so prepared retain high amount of Storage modulus or rigidity upto 400° C., indicating its utility at elevated temperatures.

Technical Advancement and Economic Significance:

The method for processing a high temperature resistant thermosetting material, namely ABPBI, in accordance with the present disclosure has several technical advantages including but not limited to the realization of:

Use of a simple yet effective technique to overcome the inherent physical barriers of the high temperature resistant thermosetting material.

A cost effective solution for processing the high temperature resistant thermosetting material.

A relatively simple and cost effective process for obtaining a precursor that could potentially replace its currently used, comparatively expensive counterparts such as metals and the like.

Throughout this specification the word “comprise”, or variations such as “comprises” or “comprising”, will be understood to imply the inclusion of a stated element, integer or step, or group of elements; integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A polymeric composition resistant to temperatures comprising:
a. Poly 2,5-Benzimidazole having inherent viscosity (I.V.) between 1.0 and 2.5; and
b. at least one binder having a glass transition temperature less than the glass transition temperature of Poly 2,5-Benzimidazole and inherent viscosity ranging between 0.2 and 1.5,
subjected to compression at a temperature ranging between 400° C. and 600° C. and a pressure ranging between 1000 psi and 10000 psi,
wherein said composition is characterized by:
i. a glass transition temperature ranging between 150 and 480° C.; and
ii. the ratio of Poly 2,5-Benzimidazole to the binder ranges between 95:5 and 5:95.

2. The polymeric composition as claimed in claim 1, wherein the binder is selected from the group consisting of Poly Ether Ketone (PEK) Poly Aryl Ether Ketone (PAEK), Poly Ether Ether Ketone, (PEEK), Poly Ether Ketone Ketone (PEKK), Polyphenelene Sulfide (PPS), Polyether Imide (PEI) Poly Ether Sulfones (PES), and Polyphenyl Sulfone (PPSU).

3. The polymeric composition as claimed in claim 1, wherein the binder is selected from the group consisting of Poly Ether Ether Ketone (PEEK) and Poly Ether Sulfone (PES).

4. A process for preparing a polymeric composition resistant to temperatures comprising Poly 2,5-Benzimidazole and at least one binder; said process comprising the following steps:
blending Poly 2,5-Benzimidazole and at least one binder to obtain a mixture; and
molding said mixture by heating at a temperature ranging between 400° C. and 600° C. for a time period ranging between 0.5 hour and 4 hours at a pressure ranging between 1000 psi and 10000 psi followed by cooling to obtain a polymeric composition resistant to temperatures in the form of a shaped article selected from the group consisting of discs, chips, plates, tubes and rods,
wherein said composition characterized in that the glass transition temperature ranging between 150 and 480° C.

5. The process as claimed in claim 4, wherein the binder is at least one compound having a glass transition temperature lower than the glass transition temperature of Poly 2,5-Benzimidazole.

6. The process as claimed in claim 4, wherein the binder is selected from the group consisting of Poly Ether Ketone (PEK), Poly Aryl Ether Ketone (PAEK), Poly Ether Ether Ketone (PEEK), Poly Ether Ketone Ketone (PEKK), Polyphenelene Sulfide (PPS), Polyether Imide (PEI) Poly Ether Sulfones (PES) and Polyphenyl Sulfone (PPSU).

7. The process as claimed in claim 4, wherein the inherent viscosity (I.V.) of Poly 2,5-Benzimidazole ranges between 1.0 and 2.5.

8. The process as claimed in claim 4, wherein the inherent viscosity of the binder ranges between 0.2 and 1.5.

9. The process as claimed in claim 4, wherein the ratio of Poly 2,5-Benzimidazole to the binder ranges from 95:5 and 5:95.
